(19) United States
(12) Patent Application Publication
(10) Pub. No.: US 2014/0347161 A1
(43) Pub. Date: Nov. 27, 2014

(54) AUTHORIZING SYSTEM AND METHOD OF PORTABLE ELECTRONIC DEVICE

(71) Applicant: HON HAI PRECISION INDUSTRY CO., LTD., New Taipei (TW)

(72) Inventor: YI-ZHONG SHEU, New Taipei (TW)

(73) Assignee: HON HAI PRECISION INDUSTRY CO., LTD., New Taipei (TW)

(21) Appl. No.: 14/092,937

(22) Filed: Nov. 28, 2013

(30) Foreign Application Priority Data
May 21, 2013 (TW) 102117819

(51) Int. Cl. G07C 9/00

(52) U.S. Cl. CPC G07C 9/00087; G07C 9/00039
USPC 340/5.53

(57) ABSTRACT

An authorizing system includes a face recognition module, a first authorizing module, a fingerprint acquiring module, and a second authorizing module. The face recognition module captures an image of a current user and recognizes face features from the image. The first authorizing module compares the face features of the current user with each group of face features pre-stored in a memory to determine whether or not the current user is authorized. The fingerprint acquiring module acquires the fingerprint of the current user and extracts fingerprint features from the fingerprint when the face features of the current user fail to match the face features stored in the memory. The second authorizing module compares the fingerprint features of the current user to each group of fingerprint features stored in the memory to determine whether or not the current user is authorized.

### BACKGROUND

1. Technical Field

The present disclosure relates to portable electronic devices, and particularly to an authorizing system and an authorizing method of a portable electronic device.

2. Description of Related Art

For security purposes, portable electronic devices require entering a password for accessing information. However, with the development of information technology, the password consisting of characters is not sufficient for ensuring the security of information.

Therefore, it is desirable to provide an authorizing system and method, which can overcome the limitations described.

### BRIEF DESCRIPTION OF THE DRAWINGS

FIG. 1 is a functional block diagram of an authorizing system in accordance with an exemplary embodiment.

FIGS. 2-3 are a flowchart of an authorizing method in accordance with an exemplary embodiment.

### DETAILED DESCRIPTION

Embodiments of the disclosure will be described with reference to the drawings.

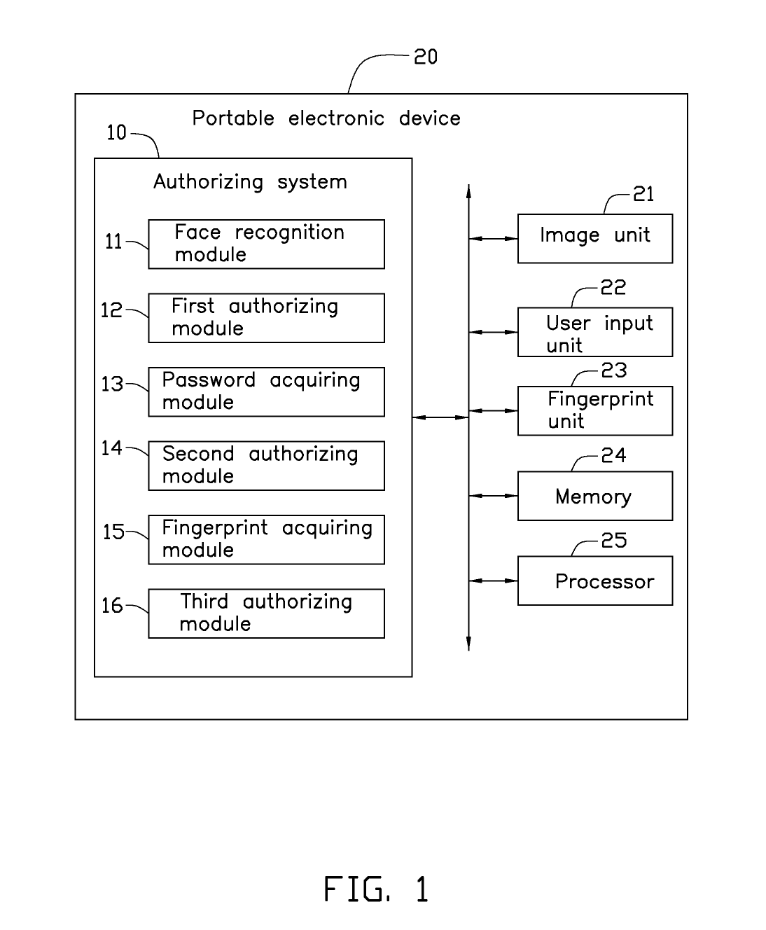

FIG. 1 shows an authorizing system 10, according to an exemplary embodiment, which is used in a portable electronic device 20. The portable electronic device 20 includes an image unit 21, a user input unit 22, a fingerprint unit 23, a memory 24, and a processor 25. The authorizing system 10 is in communication with the image unit 21, the user input unit 22, the fingerprint unit 23, the memory 24, and the processor 25.

In one embodiment, the image unit 21 is a camera and configured for capturing an image of a current user (not shown). The user input unit 22 is a keyboard and is configured for receiving a password (that is, the password is mainly consisting of characters) of the current user. The fingerprint unit 23 is a fingerprint sensor and is configured for sensing a fingerprint of the current user.

The authorizing system 10 includes a face recognition module 11, a first authorizing module 12, a password acquiring module 13, a second authorizing module 14, a fingerprint acquiring module 15, and a third authorizing module 16. The authorizing system 10 can be encoded via a program language, such as C++, or hardware constructed to have the corresponding function. The software modules can be stored in the memory 24 and run by the processor 25.

The face recognition module 11 is configured for acquiring the image of the current user from the image unit 21 and recognizing face features from the image. In practice, the face features of each user authorized to access the portable electronic device 20 are pre-stored in the memory 24 as a group of face features.

The first authorizing module 12 compares the recognized face features with each group of face features pre-stored in the memory 24 to determine whether or not the current user is authorized. The first authorizing module 12 outputs a first signal to the processor 25 when the current user is authorized, and outputs a second signal to the processor 25 when the current user is not authorized.

The password acquiring module 13 is configured for acquiring the password input by the current user from the user input unit 22. In practice, predetermined passwords authorized to access the portable electronic device 20 are pre-stored in the memory 24.

The second authorizing module 14 compares the acquired password with each predetermined password pre-stored in the memory 24 and determines whether or not the current user is one of the allowed users. The second authorizing module 14 outputs the first signal to the processor 25 when the current user is authorized, and outputs a third signal to the processor 25 when the current user is not authorized.

The fingerprint acquiring module 15 is configured for acquiring the fingerprint of the current user from the fingerprint unit 23, and extracting fingerprint features from the fingerprint. In practice, the fingerprint features of each user authorized to access the portable electronic device 20 are pre-stored in the memory 24 as a group of fingerprint features.

The third authorizing module 16 compares the extracted fingerprint with each group of fingerprint features in the memory 24 to determine whether or not the current user is authorized. The third authorizing module 16 outputs the first signal to the processor 25 when the current user is authorized, and outputs the third signal to the processor 25 when the current user is not authorized.

When the processor 25 receives the first signal, the processor 25 starts an operation system of the portable electronic device 20, the current user is authorized to enter the operation system. When the processor 25 receives the second signal, the processor 25 controls the portable electronic device 20 to display a password and fingerprint input interface. When the processor 25 receives the third signal, the processor 25 controls the portable electronic device 20 displaying an authorizing failure interface.

In use, when the portable electronic device 20 is powered on, the authorizing system 10 is started. First, the face recognition module 11 acquires the image of the current user from the image unit 21, and recognizes face features from the image. The first authorizing module 12 compares the face features of the current user with the each group of face features pre-stored in the memory 24. When the first authorizing module 12 authorizes the current user to access the operation system, the processor 25 starts the operation system of the portable electronic device 20. Otherwise, the processor 25 controls the portable electronic device 20 to display a password and fingerprint inputting interface. Then, the current user chooses to input the password or the fingerprint to determine whether or not the current user is authorized.

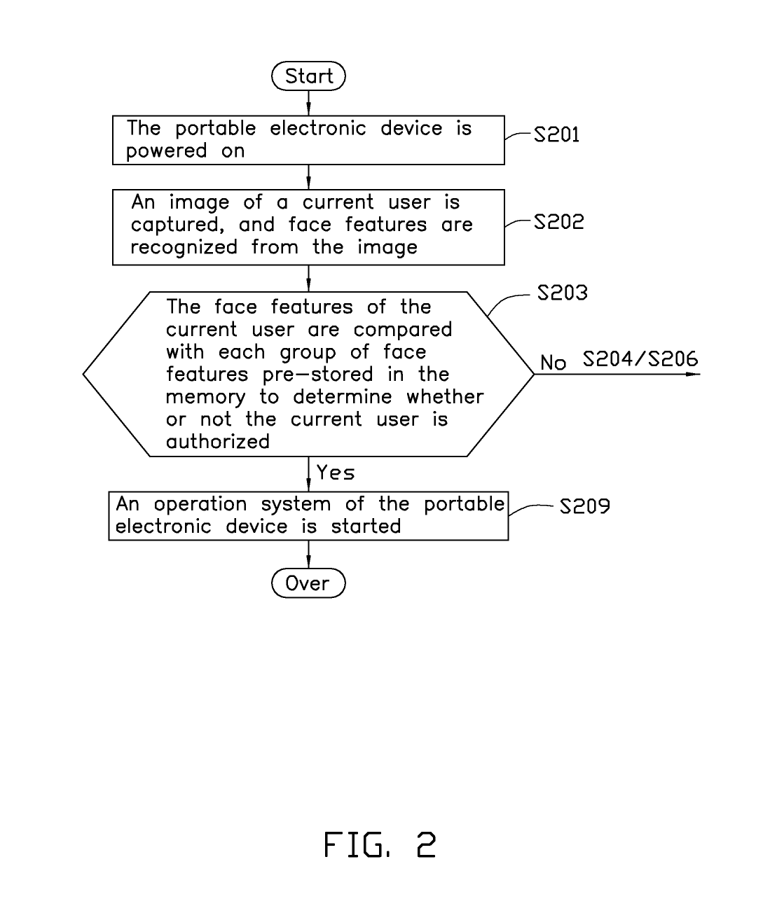

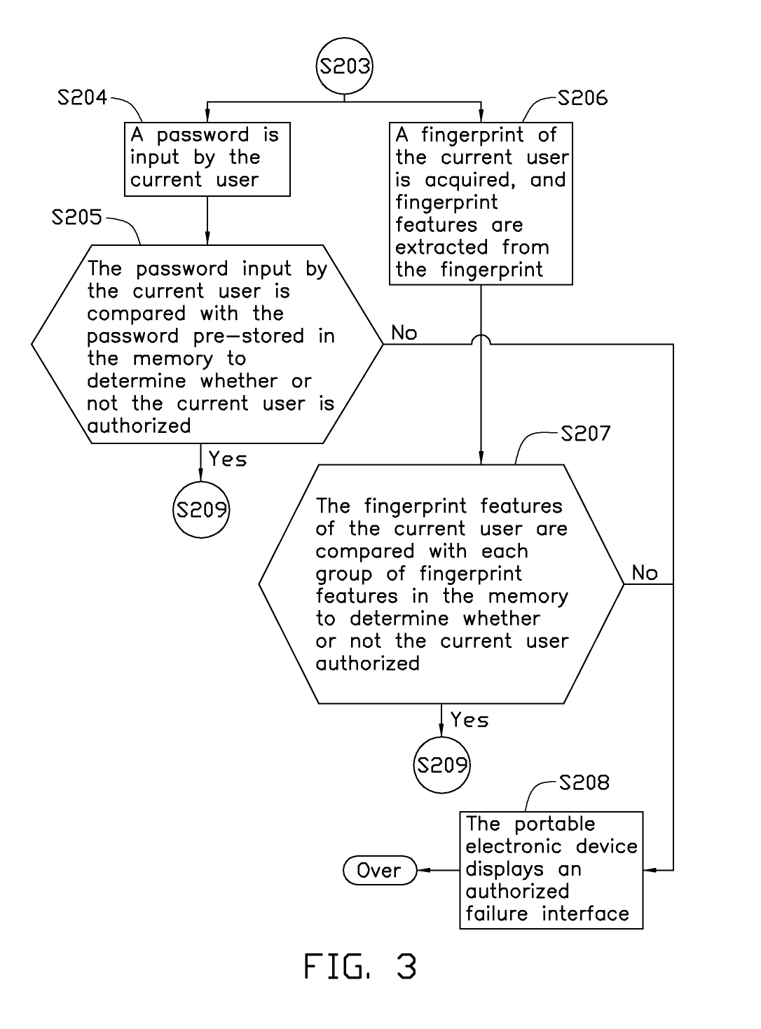

FIG. 2 shows an authorizing method, according to an exemplary embodiment, which is used in a portable electronic device 20. The authorizing method includes steps of S201-S209.

S201: the portable electronic device 20 is powered on. The portable electronic device 20 includes a power key, the portable electronic device 20 is powered on when the power key is pressed.

S202: an image of a current user is captured, and face features are recognized from the image. The current user is generally before the portable electronic device 20, the portable electronic device 20 captures the image of the current user.

S203: the face features of the current user are compared with each group of face features pre-stored in the memory 24 to determine whether or not the current user is authorized. If the current user is authorized, running step S209; if the current user is not authorized, running step S204 or step S206.

S204: a password is input by the current user. When the current user is not authorized to access an operation system of the portable electronic device 20 in step S203, the portable electronic device 20 displaying a password inputting interface.

S205: the password input by the current user is compared with the password pre-stored in the memory 24 to determine whether or not the current user is authorized. If the current user is authorized, running step S209; if the current user is not authorized, running step S208.

S206: a fingerprint of the current user is acquired, and fingerprint features are extracted from the fingerprint. When the current user is not authorized to access an operation system of the portable electronic device 20 in step S203, the portable electronic device 20 displaying a fingerprint inputting interface.

S207: the fingerprint features of the current user are compared with each group of fingerprint features in the memory 24 to determine whether or not the current user authorized. If the current user is authorized, running step S209; if the current user is not authorized, running step S208.

S208: the portable electronic device 20 displays an authorized failure interface. The current user is not authorized to access the portable electronic device 20.

S209: an operation system of the portable electronic device 20 is started. The current user is authorized to access the portable electronic device 20.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An authorizing system, comprising:
a face recognition module capturing an image of a current user and recognizing face features from the image;
a first authorizing module comparing the face features of the current user with each group of face features pre-stored in a memory to determine whether or not the current user is authorized;
a fingerprint acquiring module acquiring the fingerprint of the current user and extracting fingerprint features from the fingerprint when the face features of the current user fail to match the face features stored in the memory; and
a second authorizing module comparing the fingerprint features of the current user to each group of fingerprint features stored in the memory to determine whether or not the current user is authorized.

2. The authorizing system of claim 1, comprising: a password acquiring module acquiring the password input by the current user when the face features of the current user fail to match the face features pre-stored in the memory;
a third authorizing module comparing the password input by the current user with the password pre-stored in the memory to determine whether or not the current user is authorized.

3. The authorizing system of claim 2, wherein an operation system is started when the current user is authorized.

4. The authorizing system of claim 2, wherein the current user inputs the password or the fingerprint to determine whether or not the current user is authorized.

5. An authorizing method, comprising:
acquiring an image of a current user and recognizing face features from the image;
comparing the face features of the current user with each group of face features pre-stored in a memory to determine whether or not the current user is authorized;
acquiring the fingerprint of the current user and extracting fingerprint features from the fingerprint when the face features of the current user fail to match the face features pre-stored in the memory; and
comparing the fingerprint features of the current user with each group of fingerprint features in the memory to determine whether or not the current user is authorized.

6. The authorizing method of claim 5, further comprising: acquiring the password input by the current user when the face features of the current user fail to match the face features pre-stored in the memory;
comparing the password input by the current user with the password stored in the memory to determine whether or not the current user is authorized.

7. The authorizing method of claim 6, wherein an operation system is started when the current user is authorized, otherwise, the operation system fails to start.

8. The authorizing method of claim 6, wherein the current user chooses to input the password or the fingerprint to determine whether or not the current user is authorized.
